(19) United States
(12) Patent Application Publication
(10) Pub. No.: US 2025/0343616 A1
(43) Pub. Date: Nov. 6, 2025

(54) OPTICAL SWITCHING NETWORK AND PORTAL

(71) Applicant: Level 3 Communications, LLC, Denver, CO (US)

(72) Inventors: Thaddious Jacob DOUTHIT, III, Golden, CO (US); Kevin ROYER, Golden, CO (US)

(73) Assignee: Level 3 Communications, LLC, Denver, CO (US)

(21) Appl. No.: 19/199,572

(22) Filed: May 6, 2025

Related U.S. Application Data
(60) Provisional application No. 63/643,045, filed on May 6, 2024.

(51) Int. Cl. H04J 14/02

(52) U.S. Cl. CPC H04J 14/022; H04J 14/0212; H04J 14/0278

(57) ABSTRACT

Novel tools and techniques are provided for implementing optical switching network and portal. In various examples, a computing system of a service provider network may receive, from a first participant entity via an interface system, a request to establish or modify a network connection between a first participant network and a second participant network. The request may include a request to reserve a line port on a network device of the second participant network and/or a request for network connection at a fraction of a set bandwidth corresponding to bandwidth of cross-connections between participant networks. After confirming system capability to perform the requested establishment or modification and confirming authorization of the first participant entity to perform the requested operations, the computing system may establish or modify the network connection using an optical switching device (and in some cases, an aggregation switch) in the service provider network based on the request.

### CROSS-REFERENCE TO RELATED APPLICATIONS

This application claims the benefit of U.S. Provisional Application No. 63/643,045 filed May 6, 2024, entitled “Optical Switching Network and Portal,” which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing network services, and, more particularly, to methods, systems, and apparatuses for implementing optical switching network and portal.

### BACKGROUND

Traditionally, establishing cross-connections between a participant entity network and one or more other participant entity networks has been complicated and slow, particularly where the plurality of participant entity networks are owned, operated, and/or managed by a plurality of different participant entities. In examples, the process requires manual operation to install connectors between equipment of the participant entity and the one or more other participant entities. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing optical switching network and portal, in accordance with various embodiments.

FIG. 2 depicts another example system for implementing optical switching network and portal, in accordance with various embodiments.

FIG. 3 depicts an example user interface or portal for managing orders for establishing or modifying network connections when implementing optical switching network and portal, in accordance with various embodiments.

FIGS. 4A-4C depicts flow diagrams illustrating various example methods for implementing optical switching network and portal, in accordance with various embodiments.

FIG. 5 depicts a block diagram illustrating an exemplary computer or system hardware architecture, in accordance with various embodiments.

### DETAILED DESCRIPTION OF CERTAIN EMBODIMENTS

### Overview

In various examples, a computing system of a service provider network may receive, from a first participant entity via an interface system, a first request to establish or modify a network connection between a first participant network that is associated with the first participant entity and a second participant network that is associated with a second participant entity. In response to confirming system capability to perform the requested establishment or modification and confirming authorization of the first participant entity to establish or modify the network connection as requested, the computing system may establish or modify the network connection using an optical switching device in the service provider network. The optical switching device is configured to selectably and dynamically establish and modify cross-connections among two or more participant networks at corresponding two or more participant sites among a plurality of participant sites via a corresponding plurality of optical fiber connections each associated with one of the plurality of participant sites or one of a corresponding plurality of participant networks that is associated with a corresponding plurality of participant entities.

In an example, the first request may include a request to reserve a first line port on a first network device of the second participant network. In response to confirming availability of the first line port on the first network device of the second participant network, the computing system marking, by the computing system and in a storage device, an entry associated with the first line port indicating the first line port as being reserved to prevent use by other entities, until either completion of an order for the network connection or lapse of a predetermined period for placing the order. Establishing or modifying the network connection includes establishing or modifying the network connection between the first participant network and the first line port on the first network device of the second participant network via the optical switching device in the service provider network. Client ports that are associated with the first line port are automatically reserved and subsequently connected. Without the capability of the system to be able to identify available line ports (and associated client ports) and to reserve and connect, ports are randomly selected. However, randomly selected ports from available ports may not already be connected to the desired or selected network devices, and may require manual rewiring or connection with the desired or selected network devices.

Alternatively or additionally, in another example, the first request may (additionally) include a request to establish a network connection at a fraction of a set bandwidth, where the plurality of optical fiber connections is each configured to support data traffic at a set bandwidth or increments of the set bandwidth. Establishing or modifying the network connection includes establishing the network connection at the fraction of the set bandwidth between the first participant network and the second participant network via the optical switching device in the service provider network and via an aggregation switch. The aggregation switch is configured to aggregate a plurality of community network connections each at a fraction of the set bandwidth. The plurality of community network connections is each associated with a community entity among a plurality of community entities. The plurality of community network connections is each configured to connect one of a corresponding plurality of community networks associated with the plurality of community entities with a participant network among the plurality of participant networks via the optical switching device. In examples, a total bandwidth of the plurality of community network connections each at the fraction of the set bandwidth corresponds to the set bandwidth.

In this manner, the process of establishing (or modifying) cross-connecting network connections across two or more participant networks that are associated with different participant entities (or across different geographical locations) may be improved and made more efficient, with implementation being achievable over minutes or hours, rather than days or weeks (as manual connections are participant sites is not required after ordering by the user or requesting participant entity), and allowing for selection (and reservation) of line ports (and associated client ports) and/or for selecting network connections at less than the set bandwidth of the optical fiber connections that are used for cross-connections between two or more participant networks associated with two or more different participant entities. These and other aspects of the optical switching network and portal are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method, including receiving, by a computing system of a service provider network and from a first participant entity via an interface system, a first request to establish a network connection between a first participant network that is associated with the first participant entity and a second participant network that is associated with a second participant entity. The first request includes a request to reserve a first line port on a first network device of the second participant network. The method may further include, in response to confirming availability of the first line port on the first network device of the second participant network, marking, by the computing system and in a storage device, an entry associated with the first line port indicating the first line port as being reserved to prevent use by other entities, until either completion of an order for the network connection or lapse of a predetermined period for placing the order. The method may further include, after completion of the order for the network connection, establishing, by the computing system, the network connection between the first participant network and the first line port on the first network device of the second participant network via an optical switching device in the service provider network. In examples, the optical switching device is configured to selectably and dynamically establish cross-connections among two or more participant networks at corresponding two or more participant sites among a plurality of participant sites via a corresponding plurality of optical fiber connections each associated with one of the plurality of participant sites or one of a corresponding plurality of participant networks that is associated with a corresponding plurality of participant entities.

In another aspect, the technology relates to a system, including an optical switching device, an aggregation switch, and a computing system of a service provider network. The optical switching device is configured to selectably and dynamically establish cross-connections among two or more participant networks at corresponding two or more participant sites among a plurality of participant sites via a corresponding plurality of optical fiber connections each associated with one of the plurality of participant sites or one of a corresponding plurality of participant networks that is associated with a corresponding plurality of participant entities. The plurality of optical fiber connections is each configured to support data traffic at a set bandwidth or increments of the set bandwidth. The aggregation switch is configured to aggregate a plurality of community network connections each at a fraction of the set bandwidth. The plurality of community network connections is each associated with a community entity among a plurality of community entities. The plurality of community network connections is each configured to connect one of a corresponding plurality of community networks associated with the plurality of community entities with a participant network among the plurality of participant networks via the optical switching device. In examples, a total bandwidth of the plurality of community network connections each at the fraction of the set bandwidth corresponds to the set bandwidth.

The computing system includes a processing system and memory coupled to the processing system. The memory includes computer executable instructions that, when executed by the processing system, causes the system to perform operations including: receiving, from a first participant entity via an interface system, a first request to establish a network connection at a fraction of the set bandwidth between a first participant network that is associated with the first participant entity and a second participant network that is associated with a second participant entity among the plurality of participant entities, wherein the first participant entity is a first community entity among the plurality of community entities; and establishing the network connection at the fraction of the set bandwidth between the first participant network and the second participant network via an optical switching device in the service provider network and via an aggregation switch.

In yet another aspect, the technology relates to a method, including receiving, by a computing system of a service provider network and from a first participant entity via an interface system, a first request to establish or modify a network connection between a first participant network that is associated with the first participant entity and a second participant network that is associated with a second participant entity. The method, in response to confirming system capability to perform the requested establishment or modification and confirming authorization of the first participant entity to modify the network connection as requested, establishing or modifying, by the computing system, the network connection using an optical switching device in the service provider network. The optical switching device is configured to selectably and dynamically establish and modify cross-connections among two or more participant networks at corresponding two or more participant sites among a plurality of participant sites via a corresponding plurality of optical fiber connections each associated with one of the plurality of participant sites or one of a corresponding plurality of participant networks that is associated with a corresponding plurality of participant entities.

Various modifications and additions can be made to the embodiments discussed without departing from the scope of the invention. For example, while the embodiments described above refer to particular features, the scope of this invention also includes embodiments having different combinations of features and embodiments that do not include all of the above-described features.

### Specific Exemplary Embodiments

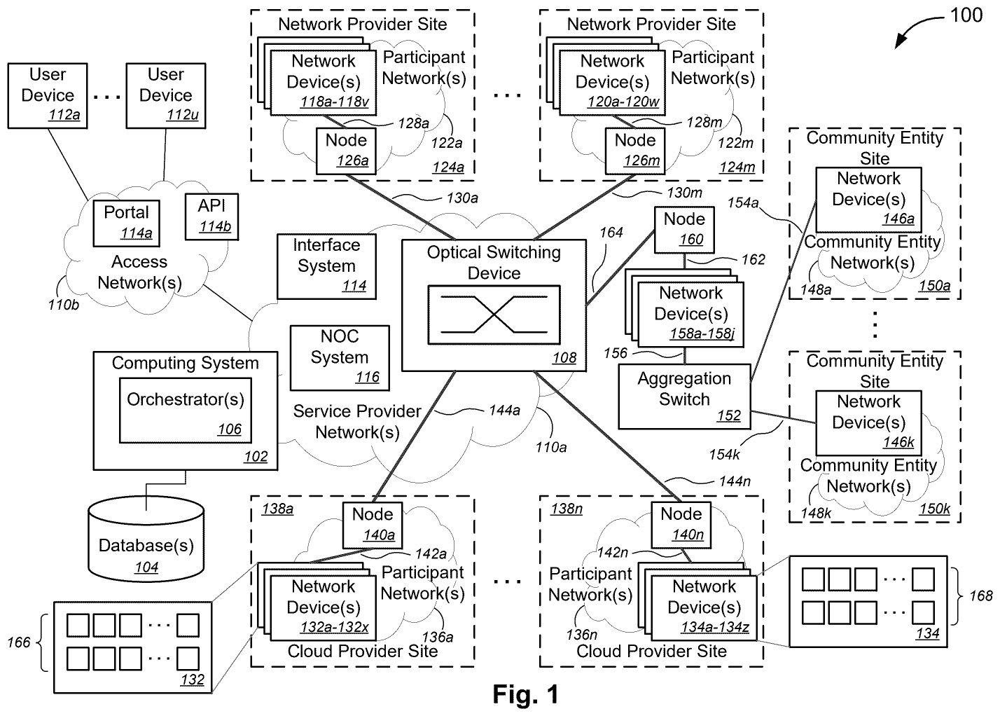

Turning to the embodiments as illustrated by the drawings, FIGS. 1-5 illustrate some of the features of the method, system, and apparatus for implementing network services, and, more particularly, to methods, systems, and apparatuses for implementing optical switching network and portal, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

With reference to the figures, FIG. 1 depicts an example system 100 for implementing optical switching network and portal, in accordance with various embodiments. In the non-limiting example of FIG. 1, system 100 may include computing system 102 and corresponding database(s) 104. In examples, computing system 102 may include one or more orchestrators 106, which may include at least one of a system orchestrator, an enterprise-to-enterprise orchestrator, an optical switch orchestrator, a multi-domain service orchestrator, or a server, and/or the like. System 100 may further include optical switching device 108. In some cases, the computing system 102, the database(s) 104, and the optical switching device 108 may be located within service provider network(s) 110a. In some examples, the orchestrator(s) 106 may be configured to control or manage operations of the optical switching device 108, and, in some cases, further configured to manage permissions, authentication, and/or authorization, in some instances, in coordination with a policy engine.

In examples, user devices 112a-112u (collectively, “user devices 112” or the like) may be associated with or operated by corresponding users who are each associated with a participant entity among a plurality of participant entities. In some instances, the user devices 112 may each include, but is not limited to, one of a desktop computer, a laptop computer, a tablet computer, a smart phone, a mobile phone, and/or the like. In some examples, the plurality of participant entities may each include one of a hyperscaler entity, an enterprise entity, a healthcare entity, an education facility entity, a government entity, a cloud service provider, or a network service provider, and/or the like. Users using the user devices 112 may request, via interface system 114 (and in some cases, via access network(s) 110b), establishment or modification of network connections across two or more participant networks 122a-122m and/or 136a-136n that are associated with corresponding two or more participant entities among the plurality of participant entities. In some instances, the interface system 114 may include at least one portal 114a and/or application programming interface (“API”) 114b, or the like, which may be located in access network(s) 110b. Similarly, agents, technicians, or network operators may utilize a network operations center (“NOC”) computing system or console 116 to request, manage, or control establishment or modification of network connections across two or more participant networks 122a-122m and/or 136a-136n, in some cases on behalf of users and/or participant entities. As described herein, the plurality of participant networks 122a-122m and 136a-136n are separate networks having separate security domains. In examples, the system enables a provider network representative (e.g., participant entity or a user associated with the participant entity) to request establishment or modification of network connections across two or more participant networks, despite the separate security domains and despite the provider network representative not having been given access within the security domains of the other participant networks.

System 100 may further include network devices 118a-118v and 120a-120w (collectively, “network devices 118,” “network devices 120,” or “network devices 118 and 120,” or the like) that are located in a corresponding plurality of participant networks 122a-122m (collectively, “participant networks 122” or the like) at a corresponding plurality of network provider sites 124a-124m (collectively, “network provider sites 124” or the like) or data centers located at those sites 124. The network devices 118 and 120 communicatively couple with corresponding nodes 126a-126m (collectively, “nodes 126” or the like) via corresponding optical fiber connections 128a-128m (collectively, “optical fiber connections 128” or the like). Nodes 126a-126m, which may each include a metropolitan or metro reconfigurable optical add-drop multiplexer (“ROADM”), communicatively couple with optical switching device 108 over service provider network(s) 110a via a corresponding plurality of optical fiber connections 130a-130m (collectively, “optical fiber connections 130” or the like) each associated with one of the plurality of network provider sites 124 or corresponding one of the plurality of participant networks 122, which is each associated with a corresponding one of the plurality of participant entities.

System 100 may further include network devices 132a-132x and 134a-134z (collectively, “network devices 132,” “network devices 134,” or “network devices 132 and 134,” or the like) that are located in a corresponding plurality of participant networks 136a-136n (collectively, “participant networks 136” or the like) at a corresponding plurality of cloud provider sites 138a-138n (collectively, “cloud provider sites 138” or the like) or data centers located at those sites 138. The network devices 132 and 134 communicatively couple with corresponding nodes 140a-140n (collectively, “nodes 140” or the like) via corresponding optical fiber connections 142a-142n (collectively, “optical fiber connections 142” or the like). Nodes 140a-140n, which may each include a metropolitan or metro ROADM, communicatively couple with optical switching device 108 over service provider network(s) 110a via a corresponding plurality of optical fiber connections 144a-144n (collectively, “optical fiber connections 144” or the like) each associated with one of the plurality of cloud provider sites 138 or corresponding one of the plurality of participant networks 136, which is each associated with a corresponding one of the plurality of participant entities.

In examples, each optical fiber connection 128 (among the plurality of optical fiber connections 128a-128m) between a network device 118 or 120 and a corresponding node 126 is configured to support data traffic at a set bandwidth (for example, but not limited to, 100 Gbps, or the like) or at increments or multiples of the set bandwidth (e.g., 200 Gbps, 400 Gbps, 800 Gbps, etc.). Similarly, each optical fiber connection 142 (among the plurality of optical fiber connections 142a-142n) between a network device 132 or 134 and a corresponding node 140 is configured to support data traffic at the set bandwidth or at increments or multiples of the set bandwidth. Each optical fiber connection (among the plurality of optical fiber connections 130a-130m and/or 144a-144n) that is associated with a corresponding one of the plurality of participant sites 124a-124m and/or 138a-138n and that is used to cross-connect two or more participant networks 122a-122m and/or 136a-136n via optical switching device 108 is configured to support data traffic at the set bandwidth or at increments or multiples of the set bandwidth (in most cases, at increments or multiples of the set bandwidth, e.g., 400 Gbps, 800 Gbps, or greater).

For accommodating users or participant entities requiring optical fiber connections less than the set bandwidth, community metro nodes or the like may be utilized according to various embodiments. For such embodiments, system 100 may further include network devices 146a-146k (collectively, “network devices 146” or the like) each located within a corresponding one of a plurality of community entity networks 148a-148k (collectively, “community entity networks 148” or the like) at a corresponding plurality of community entity sites 150a-150k (collectively, “community entity sites 150” or the like) that is associated with a corresponding plurality of community entities among the plurality of participant entities. Each network device 146 in corresponding community entity network 148 communicatively couples with an aggregation switch 152 via one of a plurality of optical fiber connections 154a-154k (collectively, “optical fiber connections 154” or “community network connections 154” or the like). The aggregation switch 152 is configured to aggregate a plurality of community network connections (in this case, optical fiber connections 154) each at a fraction of the set bandwidth (e.g., 10 Gbps, or the like). In examples, a total bandwidth of the plurality of community network connections each at the fraction of the set bandwidth corresponds to the set bandwidth (e.g., 100 Gbps, or the like). In an example, for optical fiber connection 156 configured to support a set bandwidth of 100 Gbps, 10 community network connections each at 10 Gbps may be used. In another example, for optical fiber connection 156 configured to support a set bandwidth of 100 Gbps, 5 community network connections each at 20 Gbps may be used. In yet another example, for optical fiber connection 156 configured to support a set bandwidth of 100 Gbps, 4 community network connections each at 25 Gbps may be used. And so on.

The aggregation switch 152 communicatively couples with one of a plurality of network devices 158a-158j (collectively, “network devices 158” or the like) via optical fiber connection 156. Herein, j, k, m, n, u, v, w, x, and z are non-negative integer numbers that may be either all the same as each other, all different from each other, or some combination of same and different (e.g., one set of two or more having the same values with the others having different values, a plurality of sets of two or more having the same value with the others having different values, etc.). The plurality of network devices 158 communicatively couple with node 160 via optical fiber connection 162, and the node 160 communicatively couples with optical switching device 108 in service provider network(s) 110a via optical connection 164. In an example, the node 160, the network devices 158, and the aggregation switch 152 may be located within service provider network(s) 110a. In another example, the node 160, the network devices 158, and the aggregation switch 152 may be located within a community metro network that is geographically proximate to each of the community entity sites 150a-150k. Optical fiber connection 162 between each network device 158 and node 160 is configured to support data traffic at the set bandwidth or at increments or multiples of the set bandwidth. Optical fiber connection 164 that is used to cross-connect two or more other participant networks 122a-122m and/or 136a-136n via optical switching device 108 is configured to support data traffic at the set bandwidth or at increments or multiples of the set bandwidth (in most cases, at increments or multiples of the set bandwidth, e.g., 400 Gbps, 800 Gbps, or greater).

In some examples, the optical switching device 108 includes at least one of a configurable optical switch, a gateway ROADM located at a gateway node in the service provider network, or a participant network device located at a node (e.g., node 126a-126m, 140a-140n, or node 160, or the like), in each of one or more of the plurality of participant networks (e.g., participant networks 122a-122m, 136a-136n, and/or 148a-148k, or the like), wherein the participant network device includes at least one of a network router, a network switch, a server, or a ROADM. The optical switching device 108 is configured to selectably and dynamically establish cross-connections among two or more participant networks (e.g., participant networks 122a-122m, 136a-136n, and/or 148a-148k, or the like) at corresponding two or more participant sites among a plurality of participant sites (e.g., participant sites 124a-124m, 138a-138n, and/or 150a-150k, or the like) via a corresponding plurality of optical fiber connections (e.g., optical fiber connections 130a-130m, 144a-144n, and 164, or the like) each associated with one of the plurality of participant sites or one of a corresponding plurality of participant networks (including the community metro network or community entity networks 148a-148k) that is associated with a corresponding plurality of participant entities (including the community entities). In some examples, the optical switching device 108 may utilize software-defined networking (“SDN”) to selectably and dynamically establish the cross-connections.

According to some embodiments, unless otherwise indicated, networks 110a, 110b, 122a-122m, 136a-136n, and 148a-148k may each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, unless otherwise indicated, the networks 110a, 110b, 122a-122m, 136a-136n, and 148a-148k may include an access network of the service provider (e.g., an Internet service provider (“ISP”)). In another embodiment, unless otherwise indicated, the networks 110a, 110b, 122a-122m, 136a-136n, and 148a-148k may include a core network of the service provider and/or the Internet.

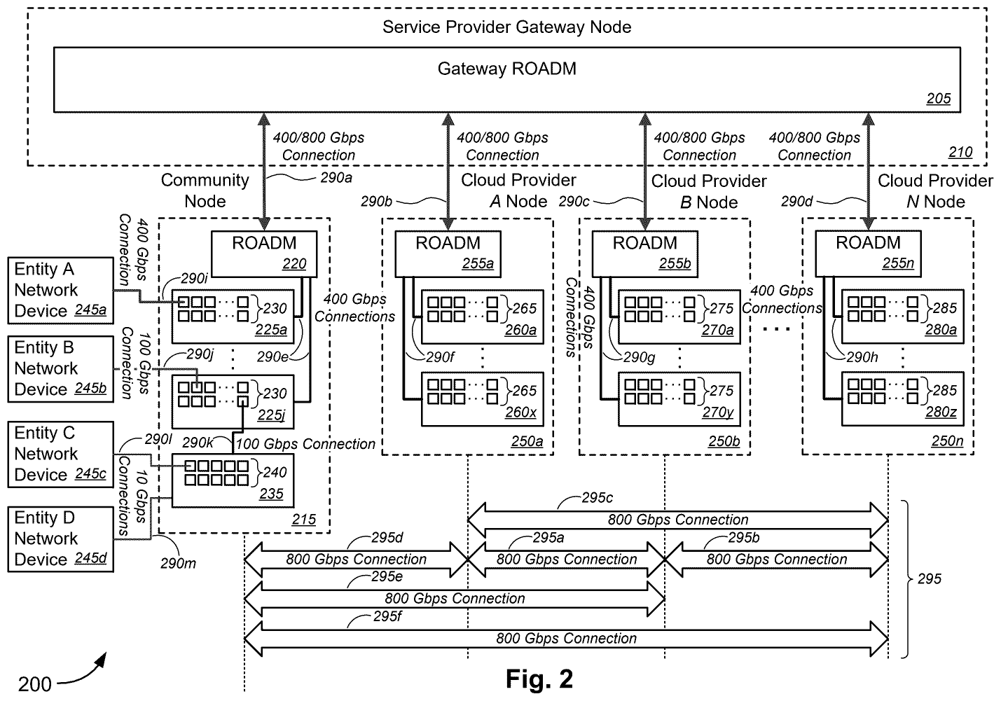

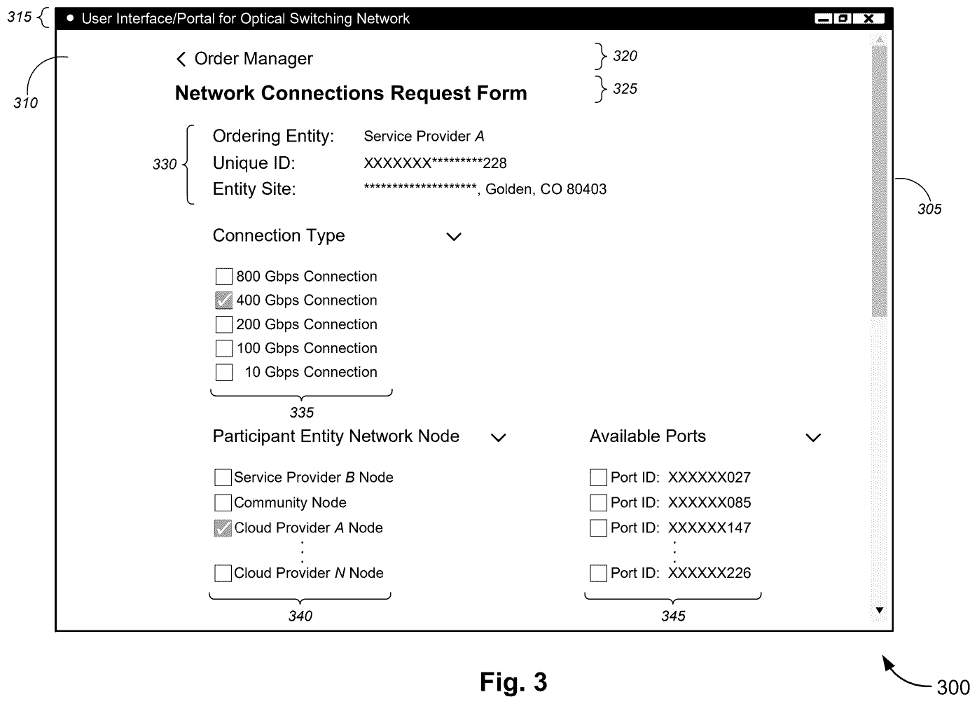

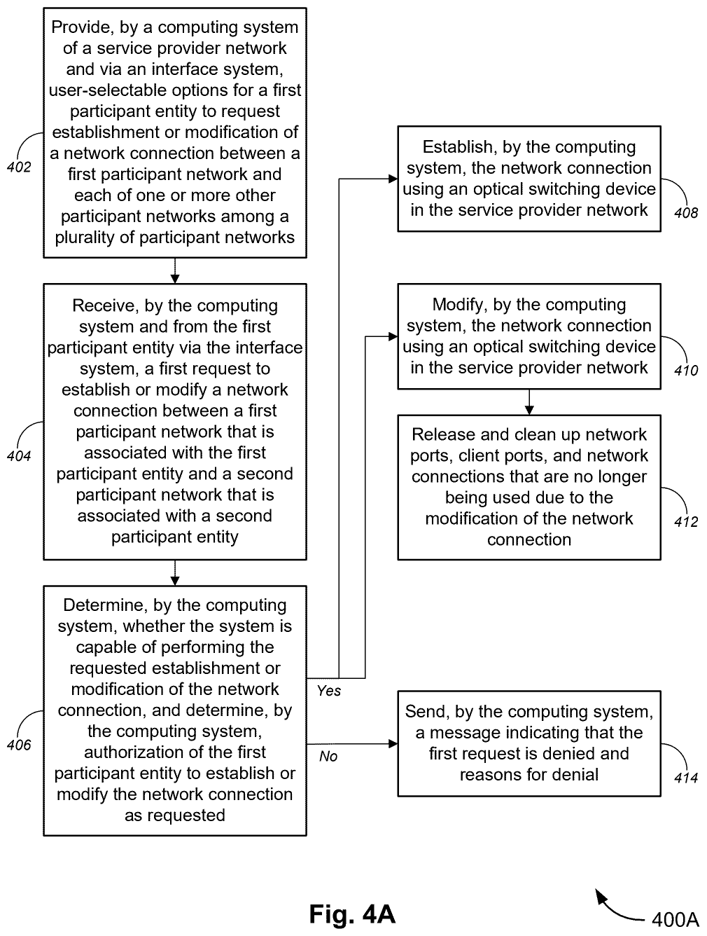

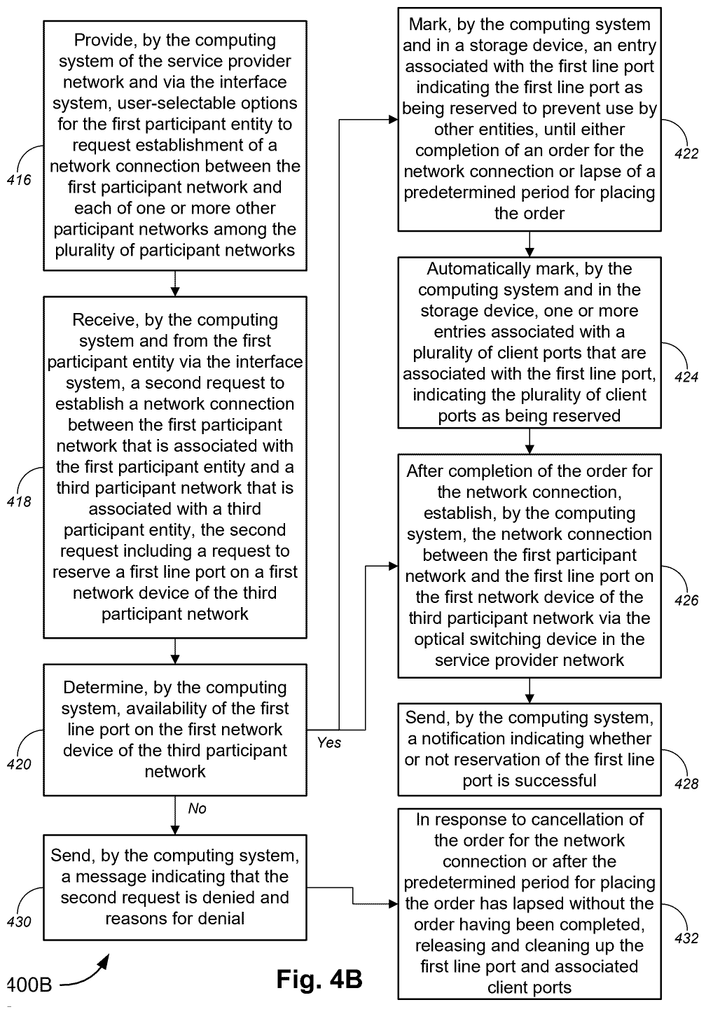

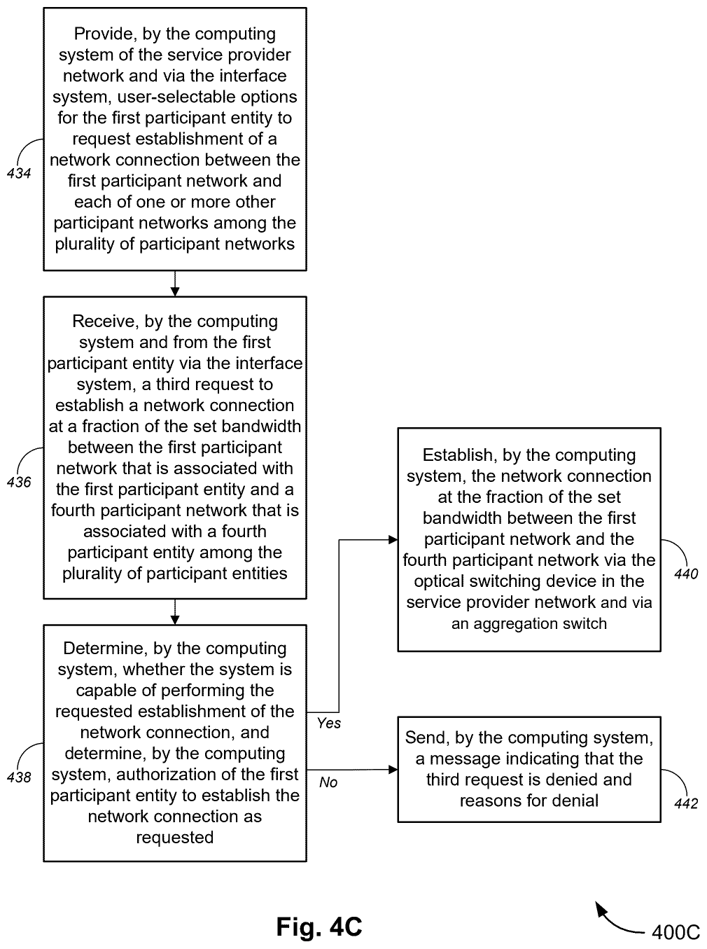

In operation, computing system 102 and/or orchestrator(s) 106 may perform methods for implementing optical switching network and portal, as described in detail with respect to FIGS. 2-4C. For example, example system 200 as described below with respect to FIG. 2 illustrates the various fiber optic connections at various bandwidths, while example interface or portal 300 is illustrated in, and described below with respect to, FIG. 3. Example system 200 of FIG. 2, example interface or portal 300 of FIG. 3, and example methods 400A-400C as described below with respect to FIGS. 4A-4C may be applied with respect to the operations of system 100 of FIG. 1.

In some aspects, users or participant entities may request establishment or modification of network connections between their participant networks and one or more other participant networks, via interface system 114 (and via at least one of portal 114a and/or API 114b; an example user interface (“UI”) of which is shown in FIG. 3). In some examples, a user or participant entity may request establishing (or modifying) a network connection to be at a fraction of the set bandwidth between the requesting participant entity's participant network or community entity network and another participant network or community entity network. That is, the connection at the fraction of the set bandwidth may be selected at the participant network connection with the optical switching device 108 or at the other participant network side, or both (assuming both sides are community entity networks). In other examples, the connection may be at a fraction of the set bandwidth at one end (i.e., one of the requesting participant entity's participant network or community entity network or the other participant network or community entity network), while the other end is at the set bandwidth or at increments or multiples of the set bandwidth (e.g., where the other end is a cloud network connection, etc.).

Alternatively or additionally, in examples, a user or participant entity may also request a line port at the network device (e.g., one of ports 166 or 168 of network devices 132a-132x or 134a-134z, or the like) at the other participant network or community entity network (such as participant network(s) 136a-136n, or the like). In such examples, the user or participant entity is first provided with a list of available line ports that are already connected to the participant networks and/or network devices that the user or participant entity is intending to (or has selected to) connect with. In some cases, reserving (or establishing connection) via the request line port automatically reserves (or establishes connection via) an associated plurality of client ports that are associated with the line port. In some instances, information associated with fiber termination panel (“FTP”) ports that are associated with the plurality of client ports may also be displayed to the requesting user or participant entity, where the information associated with the FTP ports may be obtained from the other participant network or community entity network. In the manner above, the system is able to cross-connect network devices (down to particular line ports) at various bandwidths (whether the set bandwidth, multiples of the set bandwidth, or fractions of the set bandwidth) via the optical switching device 108, by portal-based or API-based requests/commands, without need for manually connecting devices at either the requesting participant entity site or the other (requested) participant entity site(s). Accordingly, the process of establishing (or modifying) cross-connecting network connections across two or more participant networks that are associated with different participant entities (or across different geographical locations) may be improved and made more efficient, with implementation being achievable over minutes or hours, rather than days or weeks (as manual connections are participant sites is not required after ordering by the user or requesting participant entity). In examples, the API 114b includes an order management API(s) that creates, updates, and/or deletes operations in the service workflow for establishing or modifying the network connections. In some examples, instead of going through a portal graphical user interface (“GUI”), the order management API(s) may be called to enable a “single button” functionality for a provider representative to create an API to create services associated with the order management API(s). In examples, the order management API(s) includes: a get customer API (to connect with a customer), a get metro API (to connect with a metro network), a get location API (to connect with a location or site), a feasibility check API (to determine feasibility of connection), a create order API (to create an order to connect networks participant networks), a get list of tasks API (to obtain a task list), a get task information API (to obtain information on a task), a get port list API (to obtain a list of ports), a complete task API (to complete a task), a query order API (to query an order), a get list of services API (to obtain a list of services), an update service API (to update notes on the service), a delete service API (to cancel service), and an authentication API (to authenticate the provide representative).

FIG. 2 depicts another example system 200 for implementing optical switching network and portal, in accordance with various embodiments. In some embodiments, gateway ROADM 205, community node 215 or ROADM 220, cloud provider nodes 250a-250n or ROADMs 255a-255n, network devices 225a-225j and 245a-245b, aggregation switch 235, network devices 245c-245d, network devices 260a-260x, 270a-270y, and 280a-280z, line ports 265, 275, and 285, optical fiber connection 290a, optical fiber connections 290b-290d, optical fiber connections 290e-290j, optical fiber connection 290k, and optical fiber connections 290l-290m of FIG. 2 may be similar, if not identical, to the optical switching device 108, node 160 (and/or nodes 126a-126m), nodes 140a-140n, network devices 158a-158j (and/or network devices 118a-118v and 120a-120w), aggregation switch 152, network devices 146a-146k, network devices 132a-132x and 134a-134z, and line ports 166 and 168, optical fiber connection 164 (and/or optical fiber connections 130a-130m), optical fiber connections 144a-144n, optical fiber connections 142a-142n and 162, optical fiber connection 156, and optical fiber connections 154a-154k, respectively, of system 100 of FIG. 1, and the description of these components of system 100 of FIG. 1 are similarly applicable to the corresponding components of FIG. 2.

With reference to the non-limiting embodiment of FIG. 2, system 200 includes gateway ROADM 205 at service provider gateway node 210. System 200 further includes a community node 215, which may include a metro ROADM 220, a plurality of network devices 225a-225j (collectively, “network devices 225” or the like), and, in some cases, an aggregation switch 235. Each network device 225 may include a plurality of line ports 230. Similarly, aggregation switch 235 may include a plurality of line ports 240. System 200 further includes a plurality of entity network devices 245a-245d that each communicatively couples with either the network devices 225 or aggregation switch 235 (which communicatively couples with one of the network devices 225).

System 200 further includes one or more cloud provider nodes 250a-250n (collectively, “cloud provider nodes 250” or the like) that are owned, operated, or managed by participant entities who are cloud providers (also referred to as “cloud network providers” or the like). Each cloud provider node 250 may include a metro ROADM 255 among a corresponding plurality of metro ROADMs 255a-255n (collectively, “metro ROADMs 255” or “ROADMs 255” or the like) and a plurality of network devices 260a-260x (collectively, “network devices 260” or the like), 270a-270y (collectively, “network devices 270” or the like), or 280a-280z (collectively, “network devices 280” or the like). Herein, j, n, x, y, and z are non-negative integer numbers that may be either all the same as each other, all different from each other, or some combination of same and different (e.g., one set of two or more having the same values with the others having different values, a plurality of sets of two or more having the same value with the others having different values, etc.).

Gateway ROADM 205, serving as a cross-connect switch (like optical switching device 108 of FIG. 1), communicatively couples the service provider gateway node 210 with each of community node 215 and the one or more cloud provider nodes 250a-250n, via their corresponding ROADMs or metro ROADMs 220 and 255-255n, over optical fiber connections 290a-290d, each capable of supporting data traffic at increments or multiples of a set bandwidth (in this case, at bandwidths of 400 or 800 Gbps, for a set bandwidth of 100 Gbps, although not limited to these particular bandwidths). ROADM 220 communicatively couples with each of network devices 225a-225j via optical fiber connections 290e, which is capable of supporting data traffic at increments or multiples of the set bandwidth (in this case, 400 Gbps, or the like). Similarly, ROADMs 255a-255n each communicatively couples with each of its corresponding network devices 260a-260x, 270a-270y, or 280a-280z, via corresponding optical fiber connections 290f, 290g, or 290h, each of which is capable of supporting data traffic at increments or multiples of the set bandwidth (in this case, 400 Gbps, or the like). Network devices 225a-225j communicatively couple with entity network devices 245a-245b via line ports 230 and via corresponding optical fiber connections 290i-290j, each of which is capable of supporting data traffic at the set bandwidth (in this case, 100 Gbps, or the like) or at increments or multiples of the set bandwidth (in this case, 400 Gbps, or the like). Network device 225j may communicatively couple with aggregation switch 235 via one of the line ports 230 over optical fiber connection 290k, which is capable of supporting data traffic at the set bandwidth (in this case, 100 Gbps, or the like). The aggregation switch 235 may communicatively couple with entity network devices 245c-245d via line ports 240 and over corresponding optical fiber connections 290l-290m, each of which is capable of supporting data traffic at a fraction of the set bandwidth (in this case, 10 Gbps, or the like).

With these interconnections, upon receiving a request from a user or participant entity to establish or modify network connections across two or more participant nodes or networks (in this case, two or more of community node 215 and the one or more cloud provider nodes 250a-250n), the service provider gateway node 210, using the gateway ROADM 205, can perform the cross-connections, by connecting the corresponding two or more of optical fiber connections 290a-290d, then instructing corresponding two or more of ROADMs 220 and 255a-255n to connect with particular corresponding network devices among the network devices 225a-225j, 260a-260x, 270a-270y, and 280a-280z (and in some cases, particular line ports 230, 265, 275, and 280, respectively) over corresponding two or more of optical fiber connections 290e-290h, and then to entity network devices 245a-245d (or similar entity network devices or equivalent cloud provider network devices (not shown)) via line ports 240 (or equivalent line ports 240) and over corresponding optical fiber connections 290i-290m (or equivalent optical fiber connections). In examples, the ROADMs 220 and 255a-255n may be provided by the service provider managing or operating the service provider gateway node 210, although the ROADMs 220 and 255a-255n are located behind corresponding firewalls of the community node 215 and the cloud provider nodes 250a-250n.

Alternative or additional to connecting between two or more participant nodes 215 and 250a-250n via gateway ROADM 205, direct datacenter to datacenter optical fiber connection (“DC-to-DC connection”) 295 may be used that are each capable of supporting data traffic at multiples of the set bandwidth (in this case, 800 Gbps, or the like). In some cases, the direct DC-to-DC connections 295 are between two of the ROADMs 220 and 250a-250n to connect two participant nodes/networks. Alternatively, the direct DC-to-DC connections 295 are between two of the network devices among the network devices 225a-225j, 260a-260x, 270a-270y, and 280a-280z to connect two participant nodes/networks. For instance, direct DC-to-DC connection 295a connects cloud provider A node 250a (either via ROADM 255a or one of network devices 260a-260x) with cloud provider B node 250b (either via ROADM 255b or one of network devices 270a-270y). Similarly, direct DC-to-DC connection 295b connects cloud provider B node 250b (either via ROADM 255b or one of network devices 270a-270y) with cloud provider N node 250n (either via ROADM 255n or one of network devices 280a-280z). Likewise, direct DC-to-DC connection 295c connects cloud provider A node 250a (either via ROADM 255a or one of network devices 260a-260x) with cloud provider N node 250n (either via ROADM 255n or one of network devices 280a-280z). In a similar manner, direct DC-to-DC connection 295d connects community node 215 (either via ROADM 220 or one of network devices 225a-225j) with cloud provider A node 250a (either via ROADM 255a or one of network devices 260a-260x). In like manner, direct DC-to-DC connection 295e connects community node 215 (either via ROADM 220 or one of network devices 225a-225j) with cloud provider B node 250b (either via ROADM 255b or one of network devices 270a-270y). Comparably, direct DC-to-DC connection 295f connects community node 215 (either via ROADM 220 or one of network devices 225a-225j) with cloud provider N node 250n (either via ROADM 255n or one of network devices 280a-280z).

Both the optical switching device operations (via gateway ROADM 205) and the direct DC-to-DC connection-based operations (via direct DC-to-DC connections 295) allow network connections via the service provider's network, while bypassing third party data center on-ramps to the cloud provider nodes, which may require additional connections, and may require manual connections.

FIG. 3 depicts an example user interface or portal 300 for managing orders for establishing or modifying network connections when implementing optical switching network and portal, in accordance with various embodiments.

The embodiment as represented in FIG. 3 is merely illustrative and is not intended to limit the scope of the various embodiments. In addition, any suitable user device-including, but not limited to, user device(s) 112a-112u, which may each include, but is not limited to, one of a desktop computer, a laptop computer, a tablet computer, a smart phone, or a mobile phone, or any suitable device capable of communicating with interface system 114, portal 114a, API 114b, and/or computing system 102, or the like, via a web-based portal, an API, a server, an app, or any other suitable communications interface, or the like, over network(s) 110a and/or 110b of FIG. 1, and the like-may be used to display or present the example user interface 300 of FIG. 3.

As shown in the embodiment of FIG. 3, display or display screen 305 (which may be a touchscreen display or a non-touchscreen display) may display or present an app, an application window, program window or portal (e.g., web portal or the like) (collectively, “app or portal 310” or the like). In the non-limiting example of FIG. 3, the app or portal 310 running on the user device may be a user interface illustrating an order manager for an optical switching network, or the like (in some cases, including “User Interface/Portal” or the like), although the various embodiments are not limited to such an app or portal, as described herein, and can be any suitable app or portal. The app or portal 310 displayed in display 305 may provide a user (e.g., a technician, a service provider agent, or other representative, etc. of the service provider, and/or an agent of a participant entity, etc.) with the ability, functionality, or options to order, configure, and/or and manage establishment and/or modification of network connections cross-connecting two or more participant networks at corresponding two or more participant sites (as shown, e.g., in FIGS. 1 and 2, or the like).

As shown in the non-limiting example of FIG. 3, the app or portal 310 may include, without limitation, at least one of a header portion 315 (e.g., indicating the app or portal site as “User Interface/Portal for Optical Switching Network” or the like), and at least one of a section header portion 320 (e.g., indicating that a subpage of the order manager is being displayed, with a link that, when depressed, clicked, or activated, may return the user to the order manager page, or the like), a title portion 325 (e.g., indicating “Network Connections Request Form” page, or the like), a requestor information portion 330 (e.g., including, but not limited to, information regarding ordering entity (in this case, service provider A), unique ID of ordering entity, and entity site, etc.), a connection type request portion 335 (e.g., including a drop-down list of selectable connection types, including, but not limited to, 800 Gbps connection, 400 Gbps connection, 200 Gbps connection, 100 Gbps connection, 10 Gbps connection, or the like), a participant entity network node connection request portion 340 (e.g., including a drop-down list of selectable network nodes of other participant entities to connect with, including, but not limited to, service provider B node, community node, cloud provider A node through cloud provider N node, or the like), and an available ports portion 345 (e.g., including a drop-down list of selectable available line ports for the selected participant entity network node, or the like). In the example of FIG. 3, the 400 Gbps connection is selected, for connection with cloud provider A node, and available line port of cloud provider A node not yet selected. Although particular types of requestor information, connection types, participant entity network nodes, and port information are shown in FIG. 3, these are merely for purposes of illustration, and the various embodiments are not so limited and may include any suitable types of requestor information, connection types, participant entity network nodes, and port information.

FIGS. 4A-4C (collectively, “FIG. 4”) depicts flow diagrams illustrating various example methods 400A-400C for implementing optical switching network and portal, in accordance with various embodiments.

In the non-limiting embodiment of FIG. 4A, method 400A, at operation 402, may include providing, by a computing system of a service provider network and via an interface system, user-selectable options for a first participant entity to request establishment or modification of a network connection between a first participant network that is associated with the first participant entity and each of one or more other participant networks among a plurality of participant networks. In some examples, the computing system includes at least one of a system orchestrator, an enterprise-to-enterprise orchestrator, an optical switch orchestrator, a multi-domain service orchestrator, or a server, and/or the like. In some cases, the interface system includes at least one of a portal or an API, and/or the like (an example of which is shown in FIG. 3). The plurality of participant networks (including the first participant network) is associated with a corresponding plurality of participant entities each includes one of a hyperscaler entity, an enterprise entity, a healthcare entity, an education facility entity, a government entity, a cloud service provider, or a network service provider, and/or the like.

In examples, the user-selectable options include at least one of:
(a) options to establish network connections at the fraction of the set bandwidth;
(b) options to establish network connections at the set bandwidth;
(c) options to establish network connections at a multiple of the set bandwidth;
(d) options to change network connections from one bandwidth to another bandwidth among a selection of bandwidths, the selection of bandwidths including the fraction of the set bandwidth, the set bandwidth, and multiples of the set bandwidth;
(e) options to select and reserve a line port among available line ports on a network device of at least one other participant network among the one or more other participant networks for establishing the network connection between the first participant network and the at least one other participant network;
(f) options to change a current line port to a different line port among available line ports on the network device of the at least one other participant network among the one or more other participant networks for establishing the network connection between the first participant network and the at least one other participant network;
(g) options to perform service retry operations; or
(h) options to perform service cancellation operations; and/or the like.

At operation 404, method 400A includes receiving, by the computing system and from the first participant entity via the interface system, a first request to establish or modify a network connection between a first participant network that is associated with the first participant entity and a second participant network that is associated with a second participant entity. Method 400A may further include, at operation 406, determining, by the computing system, whether the system is capable of performing the requested establishment or modification of the network connection, and determining, by the computing system, authorization of the first participant entity to establish or modify the network connection as requested in the first request (from operation 404). If so, method 400A either continues onto the process at operation 408 or continues onto the process at operation 410. If not, method 400A continues onto the process at operation 414.

At operation 408, method 400A may include, in response to confirming system capability to perform the requested establishment of the network connection and confirming authorization of the first participant entity to establish the network connection as requested, establishing, by the computing system, the network connection using an optical switching device in the service provider network. Alternatively, at operation 410, method 400A may include, in response to confirming system capability to perform the requested modification and confirming authorization of the first participant entity to modify the network connection as requested, modifying, by the computing system, the network connection using the optical switching device in the service provider network. Method 400A may further include releasing and cleaning up network ports, client ports, and network connections that are no longer being used due to the modification of the network connection (at operation 412). In some cases, releasing and cleaning up network ports, client ports, and network connections may include releasing or tearing down these ports and connections in reverse order of buildup. In examples, the optical switching device is configured to selectably and dynamically establish and modify cross-connections among two or more participant networks at corresponding two or more participant sites among a plurality of participant sites via a corresponding plurality of optical fiber connections each associated with one of the plurality of participant sites or one of a corresponding plurality of participant networks that is associated with a corresponding plurality of participant entities. In some examples, the optical switching device includes at least one of a configurable optical switch, a gateway ROADM located at a gateway node in the service provider network, or a participant network device located at a node in each of one or more of the plurality of participant networks, and/or the like. In some instances, the participant network device includes at least one of a network router, a network switch, a server, or a ROADM, and/or the like.

At operation 414, in response to either determining that the system is not capable of performing the requested establishment or modification of the network connection and/or determining that the authorization of the first participant entity to establish or modify the network connection as requested, sending, by the computing system, a message or notification indicating that the first request is denied, including reasons for denial.

With reference to the non-limiting embodiment of FIG. 4B, alternative or additional to method 400A of FIG. 4A, method 400B, at operation 416, may include providing, by the computing system of the service provider network and via the interface system, user-selectable options for the first participant entity to request establishment of a network connection between the first participant network that is associated with the first participant entity and each of one or more other participant networks among the plurality of participant networks. The user-selectable options includes at least options to select and reserve a line port among available line ports on a network device of at least one other participant network among the one or more other participant networks for establishing the network connection between the first participant network and the at least one other participant network.

At operation 418, method 400B may include receiving, by the computing system and from the first participant entity via the system, a second request to establish a network connection between the first participant network that is associated with the first participant entity and a third participant network that is associated with a third participant entity among the plurality of participant entities. The second request includes a request to reserve a first line port on a first network device of the third participant network. Method 400B, at operation 420, may include determining, by the computing system, availability of the first line port on the first network device of the third participant network. If so, method 400B either continues onto the process at operation 422 and/or continues onto the process at operation 426. If not, method 400B continues onto the process at operation 430.

At operation 422, method 400B may include marking, by the computing system and in a storage device, an entry associated with the first line port indicating the first line port as being reserved to prevent use by other entities, until either completion of an order for the network connection or lapse of a predetermined period for placing the order. Method 400B may further include automatically marking, by the computing system and in the storage device, one or more entries associated with a plurality of client ports that is associated with the first line port, indicating the plurality of client ports as being reserved (at operation 424). In some examples, automatically reserving the plurality of client ports that are associated with the first line port includes displaying information associated with fiber termination panel (“FTP”) ports that are associated with the plurality of client ports, where the information associated with the FTP ports may be obtained from the third participant network. Method 400 may continue onto the process at operation 426.

At operation 426, method 400B may include, after completion of the order for the network connection (and in some cases, after reserving the first line port (at operation 422) and the plurality of associated client ports (at operation 424)), establishing, by the computing system, the network connection between the first participant network and the first line port on the first network device of the third participant network via the optical switching device in the service provider network. Method 400B may further include, at operation 428, sending, by the computing system, a notification (e.g., a notification displayed on a user device associated with the requesting user via the interface system, an email notification, and/or a notification sent via an API, etc.) indicating whether or not reservation of the first line port is successful.

At operation 430, based on a determination that the first line port is not available, sending, by the computing system, a message indicating that the second request is denied, including reasons for denial. Method 400B may further include, in response to cancellation of the order for the network connection or after the predetermined period for placing the order has lapsed without the order having been completed, releasing and cleaning up the first line port and associated client ports (at operation 432).

Referring to the non-limiting embodiment of FIG. 4C, alternative or additional to method 400A of FIG. 4A and/or method 400B of FIG. 4B, method 400C, at operation 434, may include providing, by the computing system of the service provider network and via the interface system, user-selectable options for the first participant entity to request establishment of a network connection between the first participant network and each of one or more other participant networks among the plurality of participant networks. In examples, the plurality of optical fiber connections that is associated with the plurality of participant sites and that is used for cross-connecting two or more participant networks may each be configured to support data traffic at a set bandwidth or increments of the set bandwidth. The user-selectable options that are provided (at operation 434) may include at least options to establish network connections at a fraction of the set bandwidth.

At operation 436, method 400C may include receiving, by the computing system and from the first participant entity via the interface system, a third request to establish a network connection at a fraction of the set bandwidth between the first participant network that is associated with the first participant entity and a fourth participant network that is associated with a fourth participant entity among the plurality of participant entities. Method 400C may further include, at operation 438, determining, by the computing system, whether the system is capable of performing the requested establishment of the network connection, and determining, by the computing system, authorization of the first participant entity to establish the network connection as requested. If so, method 400C continues onto the process at operation 440. If not, method 400C continues onto the process at operation 442.

At operation 440, based on a determination that the system is capable of performing the requested establishment of the network connection and that the first participant entity is authorized to establish the network connection as requested, method 400C may include establishing, by the computing system, the network connection at the fraction of the set bandwidth between the first participant network and the fourth participant network via the optical switching device in the service provider network and via an aggregation switch. In examples, the aggregation switch is configured to aggregate a plurality of community network connections each at a fraction of the set bandwidth. The plurality of community network connections is each associated with a community entity among a plurality of community entities, and the first participant entity is a first community entity among the plurality of community entities. The plurality of community network connections is each configured to connect one of a corresponding plurality of community networks associated with the plurality of community entities with a participant network among the plurality of participant networks via the optical switching device. In examples, a total bandwidth of the plurality of community network connections each at the fraction of the set bandwidth corresponds to the set bandwidth. Alternatively, at operation 442, based on a determination that the system is not capable of performing the requested establishment of the network connection and/or that the first participant entity is not authorized to establish the network connection as requested, method 400C may include sending, by the computing system, a message indicating that the third request is denied, including reasons for denial.

In some examples, with reference to FIGS. 4A-4C, the first through third requests may each include a unique ID that is associated with the first participant entity and at least one of the first participant network, a first participant site, or a service provider that owns, operates, or manages the first participant network. In such examples, establishing the network connection may include sending the unique ID to the second, third, or fourth participant network during corresponding network connection setup processes. In examples, the unique ID includes a virtual local area network (“VLAN”) tag (also referred to as “keys” or the like), which is a virtual circuit ID with information of the participant network entity and the service provider included in the tag. In some cases, the unique ID or unique key is a layer 3 key that is disseminated to the requested participant network(s) when the requesting participant entity is attempting to make a connection to the requested participant network(s). In this manner, the requested participant network entity is able to determine, based on the unique ID, information about the first participant entity and the at least one of the first participant network, the first participant site, or the service provider, in the case that information is already available to the requested participant network entity.

While the techniques and procedures in methods 400A-400C are depicted and/or described in a certain order for purposes of illustration, it should be appreciated that certain procedures may be reordered and/or omitted within the scope of various embodiments. Moreover, while the methods 400A-400C may be implemented by or with (and, in some cases, are described below with respect to) the systems, examples, or embodiments 100, 200, and 300 of FIGS. 1, 2, and 3, respectively (or components thereof), such methods may also be implemented using any suitable hardware (or software) implementation. Similarly, while each of the systems, examples, or embodiments 100, 200, and 300 of FIGS. 1, 2, and 3, respectively (or components thereof), can operate according to the methods 400A-400C (e.g., by executing instructions embodied on a computer readable medium), the systems, examples, or embodiments 100, 200, and 300 of FIGS. 1, 2, and 3 can each also operate according to other modes of operation and/or perform other suitable procedures.

### Exemplary System and Hardware Implementation

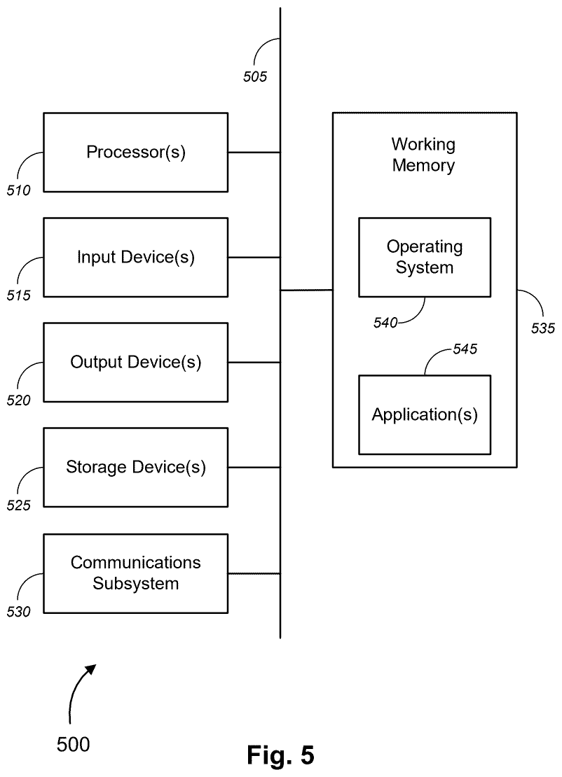

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., computing system 102, orchestrator 106, gateway node 210, and nodes 215 and 250a-250n, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., computing system 102, orchestrator 106, gateway node 210, and nodes 215 and 250a-250n, etc.), described above with respect to FIGS. 1-4—is shown including hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a Wi-Fi device, a WiMAX device, a wireless wide area network (“WWAN”) device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further include a working memory 535, which can include a RAM or ROM device, as described above.

The computer or hardware system 500 also may include software elements, shown as being currently located within the working memory 535, including an operating system 540, device drivers, executable libraries, and/or other code, such as one or more application programs 545, which may include computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that include the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with-or without-certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, by a computing system of a service provider network and from a first participant entity via an interface system, a first request to establish a network connection between a first participant network that is associated with the first participant entity and a second participant network that is associated with a second participant entity, the first request including a request to reserve a first line port on a first network device of the second participant network;
in response to confirming availability of the first line port on the first network device of the second participant network, marking, by the computing system and in a storage device, an entry associated with the first line port indicating the first line port as being reserved to prevent use by other entities, until either completion of an order for the network connection or lapse of a predetermined period for placing the order; and
after completion of the order for the network connection, establishing, by the computing system, the network connection between the first participant network and the first line port on the first network device of the second participant network via an optical switching device in the service provider network, the optical switching device being configured to selectably and dynamically establish cross-connections among two or more participant networks at corresponding two or more participant sites among a plurality of participant sites via a corresponding plurality of optical fiber connections each associated with one of the plurality of participant sites or one of a corresponding plurality of participant networks that is associated with a corresponding plurality of participant entities.

2. The method of claim 1, wherein the computing system comprises at least one of a system orchestrator, an enterprise-to-enterprise orchestrator, an optical switch orchestrator, a multi-domain service orchestrator, or a server.

3. The method of claim 1, wherein the first participant network and the second participant network are among the plurality of participant networks, the plurality of participant networks being separate networks, wherein the interface system comprises at least one of a portal or an application programming interface (“API”), wherein the method further comprises:
providing, by the computing system and via the interface system, user-selectable options for the first participant entity to request establishment of a network connection between the first participant network and each of one or more other participant networks among the plurality of participant networks, the user-selectable options including options to select and reserve a line port among available line ports on a network device of at least one other participant network among the one or more other participant networks for establishing the network connection between the first participant network and the at least one other participant network.

4. The method of claim 1, wherein the user-selectable options further include options to perform service retry operations or options to perform service cancellation operations.

5. The method of claim 1, wherein the optical switching device comprises at least one of a configurable optical switch, a gateway reconfigurable optical add-drop multiplexer (“ROADM”) located at a gateway node in the service provider network, or a participant network device located at a node in each of one or more of the plurality of participant networks, wherein the participant network device comprises at least one of a network router, a network switch, a server, or a ROADM.

6. The method of claim 1, wherein the first participant entity and the second participant entity each includes one of a hyperscaler entity, an enterprise entity, a healthcare entity, an education facility entity, a government entity, a cloud service provider, or a network service provider.

7. The method of claim 1, wherein marking the first line port as being reserved includes automatically marking, in the storage device, one or more entries associated with a plurality of client ports that are associated with the first line port, indicating the plurality of client ports as being reserved.

8. The method of claim 7, wherein automatically reserving the plurality of client ports that are associated with the first line port includes displaying information associated with fiber termination panel (“FTP”) ports that are associated with the plurality of client ports, wherein the information associated with the FTP ports is obtained from the second participant network.

9. The method of claim 1, further comprising:
sending, by the computing system, a notification indicating whether or not reservation of the first line port is successful.

10. The method of claim 1, further comprising:
in response to cancellation of the order for the network connection or after the predetermined period for placing the order has lapsed without the order having been completed, releasing and cleaning up the first line port and associated client ports.

11. The method of claim 1, wherein the plurality of optical fiber connections that is associated with the plurality of participant sites and that is used for cross-connecting two or more participant networks is each configured to support data traffic at a set bandwidth or increments of the set bandwidth, wherein the first request further includes a request for a bandwidth of the network connection that is a fraction of the set bandwidth, wherein establishing the network connection between the first participant network and the first line port on the first network device of the second participant network comprises:
establishing the network connection at the fraction of the set bandwidth between the first participant network and the first line port on the first network device of the second participant network via an optical switching device in the service provider network and via an aggregation switch;
wherein the first participant entity is a first community entity among a plurality of community entities, wherein the aggregation switch is configured to aggregate a plurality of community network connections each at the fraction of the set bandwidth, the plurality of community network connections each being associated with a community entity among the plurality of community entities, the plurality of community network connections each being configured to connect one of a corresponding plurality of community networks associated with the plurality of community entities with a participant network among the plurality of participant networks via the optical switching device, wherein a total bandwidth of the plurality of community network connections each at the fraction of the set bandwidth corresponds to the set bandwidth.

12. A system, comprising:
an optical switching device that is configured to selectably and dynamically establish cross-connections among two or more participant networks at corresponding two or more participant sites among a plurality of participant sites via a corresponding plurality of optical fiber connections each associated with one of the plurality of participant sites or one of a corresponding plurality of participant networks that is associated with a corresponding plurality of participant entities, wherein the plurality of optical fiber connections is each configured to support data traffic at a set bandwidth or increments of the set bandwidth;
an aggregation switch that is configured to aggregate a plurality of community network connections each at a fraction of the set bandwidth, the plurality of community network connections each being associated with a community entity among a plurality of community entities, the plurality of community network connections each being configured to connect one of a corresponding plurality of community networks associated with the plurality of community entities with a participant network among the plurality of participant networks via the optical switching device, wherein a total bandwidth of the plurality of community network connections each at the fraction of the set bandwidth corresponds to the set bandwidth; and
a computing system of a service provider network, comprising:
a processing system; and
memory coupled to the processing system, the memory comprising computer executable instructions that, when executed by the processing system, causes the system to perform operations comprising:
receiving, from a first participant entity via an interface system, a first request to establish a network connection at a fraction of the set bandwidth between a first participant network that is associated with the first participant entity and a second participant network that is associated with a second participant entity among the plurality of participant entities, wherein the first participant entity is a first community entity among the plurality of community entities; and
establishing the network connection at the fraction of the set bandwidth between the first participant network and the second participant network via an optical switching device in the service provider network and via an aggregation switch.

13. The system of claim 12, wherein the computing system comprises at least one of a system orchestrator, an enterprise-to-enterprise orchestrator, an optical switch orchestrator, a multi-domain service orchestrator, or a server.

14. The system of claim 12, wherein the interface system comprises at least one of a portal or an application programming interface (“API”), wherein the operations further comprise:
providing, via the interface system, user-selectable options for the first participant entity to request establishment of a network connection between the first participant network and each of one or more other participant networks among the plurality of participant networks;
wherein the user-selectable options include at least one of:
options to establish network connections at the fraction of the set bandwidth;
options to establish network connections at the set bandwidth;
options to establish network connections at a multiple of the set bandwidth;
options to select and reserve a line port among available line ports on a network device of at least one other participant network among the one or more other participant networks for establishing the network connection between the first participant network and the at least one other participant network;
options to perform service retry operations; or
options to perform service cancellation operations.

15. The system of claim 12, wherein the set bandwidth is 100 Gbps and the fraction of the set bandwidth is 10 Gbps.

16. The system of claim 12, wherein the request includes a unique identifier (“ID”) that is associated with the first participant entity and at least one of the first participant network, a first participant site, or a service provider that owns, operates, or manages the first participant network, wherein establishing the network connection includes sending the unique ID to the second participant network during network connection setup processes.

17. A method, comprising:
receiving, by a computing system of a service provider network and from a first participant entity via an interface system, a first request to establish or modify a network connection between a first participant network that is associated with the first participant entity and a second participant network that is associated with a second participant entity; and
in response to confirming system capability to perform the requested modification and confirming authorization of the first participant entity to establish or modify the network connection as requested, establishing or modifying, by the computing system, the network connection using an optical switching device in the service provider network, the optical switching device being configured to selectably and dynamically establish and modify cross-connections among two or more participant networks at corresponding two or more participant sites among a plurality of participant sites via a corresponding plurality of optical fiber connections each associated with one of the plurality of participant sites or one of a corresponding plurality of participant networks that is associated with a corresponding plurality of participant entities.

18. The method of claim 17, wherein the computing system comprises at least one of a system orchestrator, an enterprise-to-enterprise orchestrator, an optical switch orchestrator, a multi-domain service orchestrator, or a server.

19. The method of claim 17, wherein the interface system comprises at least one of a portal or an application programming interface (“API”), wherein the method further comprises:
providing, by the computing system and via the interface system, user-selectable options for the first participant entity to request establishment or modification of a network connection between the first participant network and each of one or more other participant networks among the plurality of participant networks;
wherein the user-selectable options include at least one of:
options to establish network connections at the fraction of the set bandwidth;
options to establish network connections at the set bandwidth;
options to establish network connections at a multiple of the set bandwidth;
options to change network connections from one bandwidth to another bandwidth among a selection of bandwidths, the selection of bandwidths including the fraction of the set bandwidth, the set bandwidth, and multiples of the set bandwidth;
options to select and reserve a line port among available line ports on a network device of at least one other participant network among the one or more other participant networks for establishing the network connection between the first participant network and the at least one other participant network;
options to change a current line port to a different line port among available line ports on the network device of the at least one other participant network among the one or more other participant networks for establishing the network connection between the first participant network and the at least one other participant network;
options to perform service retry operations; or
options to perform service cancellation operations.

20. The method of claim 17, further comprising:
releasing and cleaning up network ports, client ports, and network connections that are no longer being used due to modification of the network connection.
